(19) United States
(12) Patent Application Publication
(10) Pub. No.: US 2006/0256178 A1
(43) Pub. Date: Nov. 16, 2006

(54) Inkjet printer

(75) Inventor: Hyeong-Ill Lee, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/378,399

(22) Filed: Mar. 20, 2006

(30) Foreign Application Priority Data
May 10, 2005 (KR) 2005-38999

(51) Int. Cl. B41J 2/01

(52) U.S. Cl. 347/101

(57) ABSTRACT

An inkjet printer includes a paper-feeding unit and a plurality of printheads. The paper-feeding unit feeds paper in a progression direction. The printheads have a length greater than a width of the paper and arranged in a line along the progression direction of the paper fed by the paper-feeding unit to fire ink on the paper.

### CROSS-REFERENCE TO RELATED PATENT APPLICATION

This application claims the benefit of Korean Patent Application No. 2005-38999, filed on May 10, 2005 in the Korean Intellectual Property Office, the disclosure of which is incorporated herein in its entirety by reference.

### BACKGROUND OF THE INVENTION

1. Field of the Invention

Aspects of the present invention relate to an inkjet printer, and more particularly, to an inkjet printer capable of ejecting ink to form an image without moving printheads in the width direction of paper by providing the printheads having a length greater than the width of paper.

2. Description of the Related Art

Generally, inkjet printers are classified into direct printing type inkjet printers and indirect printing type inkjet printers according to an image-forming type. Direct printing type inkjet printers print an image by firing ink using a printhead directly onto paper. In contrast, indirect printing type inkjet printers print an image by firing ink onto an intermediate transfer medium using a printhead and transferring the image onto paper.

FIG. 1 is a view of a conventional indirect printing type inkjet printer disclosed in U.S. Pat. No. 6,113,231. Referring to FIG. 1, the inkjet printer 10 has sixteen printheads 20 radially and fixedly disposed around a drum 15. The drum 15 is an intermediate transfer medium. When the drum 15 rotates, the printheads 20 sequentially fire ink onto the surface of the drum 15 so that an image is formed on the drum 15. The image formed on the surface of the drum 15 is transferred onto paper that passes between the drum 15 and a transfer roller 25. The image is fused on the paper using a fusing unit 30, and then the paper with the image is discharged to the outside of the inkjet printer 10.

In such a structure, the inkjet printer 10 requires the drum 15, which is the intermediate transfer medium, and a driving unit for the drum 15, so that the structure of the inkjet printer is complicated. Thus, the manufacturing cost increases, and it is difficult to manufacture a small-sized inkjet printer. Also, since the printheads 20 should be fixedly installed around the drum 15, it is difficult to accurately align the respective printheads 20 and thus, an image may be distorted. In contrast to the conventional indirect printing type inkjet printer, the conventional direct printing type inkjet printer has a single printhead. Thus, in direct printing type inkjet printers, the number of nozzles is limited and thus, a printing speed cannot be increased.

### SUMMARY OF THE INVENTION

Aspects of the present invention provide a direct printing type inkjet printer capable of increasing a printing speed by providing a plurality of printheads.

Additional aspects and/or advantages of the invention will be set forth in part in the description which follows and, in part, will be obvious from the description, or may be learned by practice of the invention.

According to an aspect of the present invention, an inkjet printer includes: a paper-feeding unit feeding paper in one direction; and a plurality of printheads having a length greater than a width of the paper and are arranged in a line along a progression direction of the paper fed by the paper-feeding unit to fire ink on the paper.

According to an aspect of the present invention, the paper-feeding unit includes: a first support roller disposed before a first printhead along the progression direction of the paper; a second support roller disposed after a last printhead along the progression direction of the paper; and a feeding belt wound on the first support roller and the second support roller to revolve thereon and feeding the paper.

According to an aspect of the present invention, the first support roller is an idle roller driven by movement of the feeding belt and the second support roller is a driving roller driving the feeding belt.

According to an aspect of the present invention, the inkjet printer further includes a fusing roller disposed on an opposite side of the second support roller with the feeding belt interposed therebetween and applying heat and pressure to the paper so as to fuse fired ink on the paper.

According to an aspect of the present invention, the fusing roller has a heat source therein and is elastically pressurized against a side of the second support roller.

According to an aspect of the present invention, the inkjet printer further includes a feeding roller disposed on an opposite side of the first support roller with the feeding belt interposed therebetween and feeding the paper into the feeding belt.

According to an aspect of the present invention, the feeding roller has a heat source therein so as to preheat a paper progressing toward the printhead.

According to an aspect of the present invention, the inkjet printer further includes a paper guide closely attaching the paper on a surface of the feeding belt and guiding a progression path of the paper.

According to an aspect of the present invention, the inkjet printer further includes an ink-supply unit liquefying ink in a solid state at the room temperature to supply ink to the printheads.

### BRIEF DESCRIPTION OF THE DRAWINGS

The above and/or other features and advantages of the present invention will become more apparent and more readily appreciated by describing in detail exemplary embodiments thereof with reference to the accompanying drawings in which:

FIG. 1 is an exemplary view of a conventional inkjet printer;

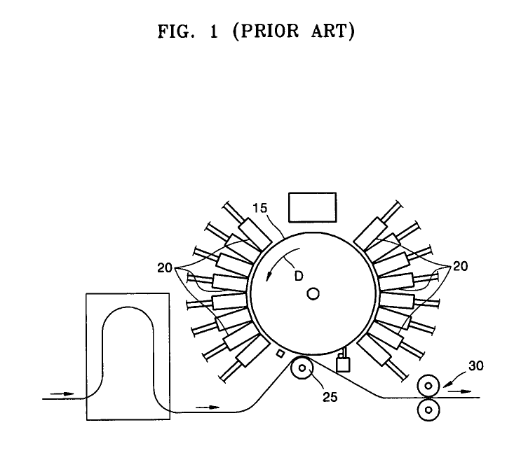

FIG. 2 is a sectional view of an inkjet printer according to an embodiment of the present invention; and

FIG. 3 is a perspective view of a part of the inkjet printer illustrated in FIG. 2.

### DETAILED DESCRIPTION OF THE EMBODIMENTS

Aspects of the present invention will now be described more fully with reference to the accompanying drawings, in which exemplary embodiments of the invention are shown and where like reference numerals refer to the like elements throughout. The embodiments are described below in order to explain the present invention by referring to the figures.

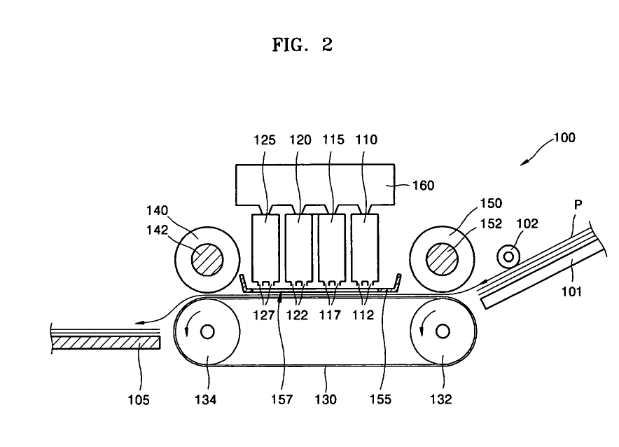

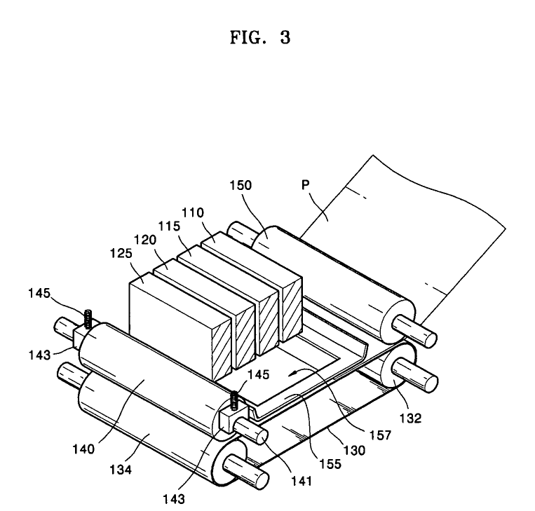

FIG. 2 is a sectional view of an inkjet printer according to an embodiment of the present invention. FIG. 3 is a perspective view of a part of the inkjet printer illustrated in FIG. 2. Referring to FIGS. 2 and 3, the inkjet printer 100 includes first through fourth printheads 110, 115, 120, and 125 arranged in a line that is substantially parallel to a feed direction of paper P being printed. A paper-feeding unit feeds the paper P so that the paper P sequentially passes through the four printheads 110, 115, 120, and 125 along the feed direction. The printheads 110, 115, 120, and 125 have a length greater than a width of the paper P, where the length of the printheads 110, 115, 120, and 125 and the width of the paper P is substantially perpendicular to the feed direction. The bottom surfaces of the printheads 110, 115, 120, and 125 are nozzle surfaces and have a plurality of nozzles 112, 117, 122, and 127 extending in the width direction of the paper P, which is a main scanning direction. In the inkjet printer 100, the respective nozzles 112, 117, 122, and 127 simultaneously fire ink in the main scanning direction so that an image is formed on the paper P in line units and the printheads 110, 115, 120, and 125 do not make a reciprocating motion but are fixed in the width direction of the paper P. It is understood that additional printheads 110, 115, 120, and 125 could be used according to other aspects of the invention.

As shown, conventional paper widths for most normal print jobs (i.e., 8½by 11 and A4 paper) are contemplated such that the length of the printheads 110, 115, 120, and 125 would be greater than or equal to 8.5 inches or 21 centimeters. However, it is understood that other widths can be used according to other aspects of the invention.

Moreover, it is understood that other orientations of the paper P are possible so long as the length of the printheads 110, 115, 120, and 125 is longer than the widest point of the paper P in the main scanning direction as the paper P passes under the printheads 110, 115, 120, and 125 in the feed direction according to other aspects of the invention. Lastly, it is understood that the lengths of the printheads 110, 115, 120, and 125 need not be greater than the width of the paper P, and some or all of the printheads 110, 115, 120, and 125 can be substantially equal to the width where margins of the paper P are not generally used for printing according to aspects of the invention.

The inkjet printer 100 further includes an ink-supply unit 160 supplying ink to the printheads 110, 115, 120, and 125. The ink-supply unit 160 includes a reservoir of the ink, heats ink in a solid state at room temperature to be changed into a liquid state and supplies ink in a liquid state to the respective printheads 110, 115, 120, and 125. Since the configuration of the respective printheads 110, 115, 120, and 125 or the configuration of the ink-supply unit 160 is known to those skilled in the art, a detailed description thereof will be omitted. While shown with a single unit 160, it is understood that plural units 160 could be used, such as when ones of the printheads 110, 115, 120, 125 supply a corresponding color according to aspects of the invention.

Also, it is understood that the combination of the printheads 110, 115, 120, and 125 and the ink-supply unit 160 can be supplied as a removable cartridge to allow easy replacement when the ink-supply unit 160 is emptied of ink according to aspects of the invention. Alternately, combinations of the printheads 110, 115, 120, and 125 and the ink-supply unit 160 can be individually replaceable, or a reservoir of the ink-supply unit 160 can be recharged with ink so as to not require replacement of the printheads 110, 115, 120, and 125 and/or the ink-supply unit 160 according to aspects of the invention.

The paper-feeding unit of the shown embodiment includes a first support roller 132 disposed before the first printhead 110 along the progression direction of the paper P. A second support roller 134 is disposed after the fourth printhead 125 along the progression direction of the paper P. A feeding belt 130 is wound on the first support roller 132 and the second support roller 134 to revolve thereon, attaching the paper P on the surface thereof, and feeding the paper P. The first support roller 132 is an idle roller driven by the traveling of the feeding belt 130, and the second support roller 134 is a driving roller receiving power from a drive source such as a motor (not shown) so as to drive the feeding belt 130. The second support roller 134 rotates counterclockwise to allow the feeding belt 130 to travel counterclockwise. The paper P is attached to the feeding belt 130 and fed in a direction toward the fourth printhead 125 from the first printhead 110. The inkjet printer 100 may further include an element generating static electricity on the paper P so as to enhance a sticking force between the paper P and the feeding belt 130. However, it is understood that other types of paper feed units can be used. For instance, it would be possible to have the first support roller 132 be a driving roller in addition to or instead of the roller 134. Moreover, it is understood that belt 130 need not be used in all implementations.

The inkjet printer 100 further includes a paper-supply tray 101 in which the paper P to be fed to the feeding belt 130 is stacked. An auto-sheet-feeder (ASF) roller 102 picks up the paper P stacked on the paper-supply tray 101 and feeds the same sheet by sheet. Also, the inkjet printer 100 further includes a paper-discharging tray 105 in which the paper P having a printed image and discharged from the feeding belt 130 is stacked. However, it is understood that other input and output mechanisms can be used, and that one or both trays 101, 105 can be omitted.

Also, the inkjet printer 100 further includes a feeding roller 150 disposed on an opposite side of the first support roller 132 with the feeding belt 130 interposed therebetween. The feeding roller 150 feeds the paper P picked up by the ASF roller 102 to the feeding belt 130. The feeding roller 150 has a heat source 152 therein so as to preheat the paper P before ink is fired. When liquefied ink is fired onto the paper P of low temperature, the ink is solidified as soon as ink reaches the paper P. Thus, the ink does not have time to spread properly due to this low temperature, so that a printed image quality may deteriorate and become non-uniform depending on the outside temperature. Since the inkjet printer 100 preheats the paper P using the heat source 152 installed inside of the feeding roller 150 before the ink is fired, the above problem is prevented. A halogen lamp, a heat coil, or an induction heater may be used as the heat source 152, and the preheating temperature may be in the range of 60-70° C. However, it is understood that other heat sources can be used, and that the heat source need not be used in all aspects of the invention.

The inkjet printer 100 further includes: a fusing roller 140 disposed on an opposite side of the second support roller 134 with the feeding belt 130 interposed therebetween. The fusing roller 140 applies heat and pressure to an ink-fired paper P to fuse ink on the paper P. The fusing roller 140 has a heat source 142 therein for heating an ink-fired paper P therein. Shafts 141 at both ends of the fusing roller 140 are rotatably supported by bushes 143. The bushes 143 are elastically pressurized by a spring 145. Therefore, the fusing roller 140 is elastically pressurized against the side of the second support roller 134. A halogen lamp, a heat coil, or an induction heater may be used as the heat source 142. However, it is understood that other heat sources can be used, and that the heat source need not be used in all aspects of the invention.

The inkjet printer 100 further includes a paper guide 155 closely attaching the paper P on the surface of the feeding belt 130, so that the paper P may not be detached from the surface of the feeding belt 130. The paper guide 155 has a central ink-firing region 157 so as to not to cover the nozzles 112, 117, 122, and 127, and closely attaches both sides of the fed paper P on the surface of the feeding belt 130. As such, a distance between the paper P and the nozzles 112, 117, 122, and 127 is maintained, which further improves the printed image quality. It is noted that the printheads 110, 115, 120, 125 are only partially shown in FIG. 3 to allow viewing of the guide 155, but otherwise extend across the paper P widthwise in the main scanning direction.

A printing process of the inkjet printer 100 will be described. Paper P stacked on the paper-supply tray 101 is picked up by the ASF roller 102, preheated by the heat source 150, and simultaneously, fed to the traveling feeding belt 130 by the feeding roller 150. Ink liquefied by the ink-supply unit 160 is supplied to the four printheads 110, 115, 120, and 125, respectively. The feeding belt 130 feeds the paper P in the feeding direction to sequentially pass below the first through four printheads 110, 115, 120, and 125. As the paper P passes, ink is fired from the nozzles 112, 117, 122, and 127 of the respective printheads 110, 115, 120, and 125 to form an image on the paper R As the ink-fired paper P passes through the fusing roller 140, heat and pressure are applied to the paper P using the heat source 142 so that the formed image is fused on the paper P. The paper P that has passed through the fusing roller 140 is stacked on the paper-discharging tray 105. The inkjet printer 100 has the four printheads 110, 115, 120, and 125, so that the ink-firing burden of each printhead is reduced to one fourth as compared with the conventional firing inkjet printer having one printhead. Therefore, since a time consumed for firing ink when printing an image of the same resolution is reduced to one fourth, a printing speed increases. It is understood that the printheads 110, 115, 120, 125 can be of a type such as bubble jet, piezo electric, or other technologies which form jets of ink.

While described in terms of the paper P passing under the printheads 110, 115, 120, 125, it is possible to achieve this relative motion by having the printheads 110, 115, 120, 125 pass over the paper P or using a combination of such movements according to other aspects of the invention.

The inkjet printer according to aspects of the present invention can increase a printing speed of the direct printing type inkjet printer by providing a plurality of printheads. In an embodiment of the present invention, paper is preheated before ink is ejected and an image formed by ink firing can be fused on the paper with heat and pressure, so that printed image quality can be improved. Also, in an embodiment of the present invention, the paper guide makes a distance between the nozzles and the paper constant, so that printed image quality can be improved. Also, while described as width of the paper, it is understood that width is relative to traveling direction of the paper. The number of the printheads of the inkjet printer according to aspects of the present invention is not limited to four, but can be other numbers, such as two or eight printheads. Further, while designed for a specific width, it is understood that the printheads could be movable to allow printing to paper widths wider than the paper width for which the printheads were primarily designed.

It is understood that aspects of the invention can be implemented by non-ink-jets, can be used for media other than paper, can be used with other image producing media other than ink, and can be used in printers used in copiers, fax machines and/or multi-function devices.

While the present invention has been particularly shown and described with reference to exemplary embodiments thereof, it will be understood by those of ordinary skill in the art that various changes in form and details may be made therein without departing from the spirit and scope of the present invention as defined by the following claims and equivalents thereof.

What is claimed is:

1. An inkjet printer comprising:
a feeding unit feeding a medium in a progression direction, the medium having a width substantially perpendicular to the progression direction; and
a plurality of printheads having a length substantially perpendicular to the progression direction that is greater than the width of the medium, the printheads being arranged in a line along the progression direction of the medium fed by the feeding unit to fire ink on the medium.

2. The inkjet printer of claim 1, wherein the feeding unit comprises:
a first support roller disposed before a first one of the printheads along the progression direction of the medium;
a second support roller disposed after a last one of the printheads along the progression direction of the medium; and
a feeding belt wound on the first support roller and the second support roller to revolve thereon and feed the medium past the plurality of printheads.

3. The inkjet printer of claim 2, wherein the first support roller is an idle roller that is driven by the revolving of the feeding belt, and the second support roller is a driving roller driving the feeding belt to revolve and drive the first support roller.

4. The inkjet printer of claim 2, further comprising: a fusing roller disposed on an opposite side of the second support roller with the feeding belt interposed therebetween and applying heat and pressure to the medium so as to fuse fired ink on the medium.

5. The inkjet printer of claim 4, wherein the fusing roller further comprises a heat source and is elastically pressurized towards a side of the second support roller so as to press on the medium therebetween.

6. The inkjet printer of claim 2, further comprising: a feeding roller disposed on an opposite side of the first support roller with the feeding belt interposed therebetween and feeding the medium to the feeding belt.

7. The inkjet printer of claim 6, wherein the feeding roller further comprises a heat source so as to preheat the medium progressing toward the printheads.

8. The inkjet printer of claim 2, further comprising: a guide closely attaching the medium on a surface of the feeding belt and guiding the progression path of the medium.

9. The inkjet printer of claim 1, further comprising: an ink-supply unit liquefying ink in a solid state at room temperature to supply liquefied ink to the printheads.

10. A printer for use in printing an image on a medium, comprising:
a print unit having a plurality of printheads arranged in a line and which jet ink in a scanning direction to impart the image on the medium; and
a conveyer unit to convey the medium relative to the print unit in a progression direction that is both substantially perpendicular to the scanning direction and substantially parallel to the line of the printheads,
wherein at least one of the plurality of printheads has a length in the scanning direction that is at or greater than a maximum printable width of the medium in the scanning direction.

11. The printer of claim 10, wherein the medium comprises paper having a width in the scanning direction, and the length of each of the printheads is greater than or equal to the paper width.

12. The printer of claim 10, further comprising an input unit which feeds the medium into the conveyer unit.

13. The printer of claim 12, wherein the input unit further comprises a heater unit which heats the medium as the medium is fed into the conveyer unit.

14. The printer of claim 13, wherein the heater unit heats the medium to a temperature in a range at or between 60° C. and 70° C.

15. The printer of claim 10, further comprising an output unit which feeds the medium out of the conveyer unit and fuses the image onto the medium.

16. The printer of claim 15, wherein the output unit further comprises a heater unit which heats the medium as the medium is fed from the conveyer unit.

17. The printer of claim 10, wherein the print unit further comprises one or more ink reservoirs to feed the ink to the corresponding plurality of printheads to impart the image onto the medium, where the imparted image has at least one color.

18. A cartridge for use in an inkjet printer, comprising
at least one ink reservoir holding ink to be jetted by the inkjet printer onto a medium; and
a plurality of printheads connected to the at least one ink reservoir, the printheads being arranged in a line substantially along which the medium is conveyed by the inkjet printer as the inkjet printer jets the ink onto the medium in a scanning direction, where each of the plurality of printheads has a length in the scanning direction that is at or greater than a maximum printable width of the medium in the scanning direction.

19. The cartridge of claim 18, wherein the medium comprises paper having a width in the scanning direction, and the length of each of the printheads is greater than or equal to the width.
